(19) United States
(12) Patent Application Publication
(10) Pub. No.: US 2026/0175892 A1
(43) Pub. Date: Jun. 25, 2026

(54) Sanitary or Anti-Contamination Frame For a Cart

(71) Applicant: AMERISAN, Boothwyn, PA (US)

(72) Inventors: Kevin BOYT, Newton Square, PA (US); Anthony John EWING, Broomall, PA (US)

(21) Appl. No.: 19/428,922

(22) Filed: Dec. 22, 2025

Related U.S. Application Data
(60) Provisional application No. 63/737,842, filed on Dec. 23, 2024.
(60) Provisional application No. 63/737,354, filed on Dec. 20, 2024.

(51) Int. Cl. B62B 3/04

(52) U.S. Cl. CPC B62B 3/04; B62B 2202/50

(57) ABSTRACT

A sanitary frame for a supported element includes an upright member having an upright-member cross section. The upright-member cross section is open-shaped. A cross member has a cross-member cross section, and the cross-member cross section is open-shaped. A plurality of offset mounting elements is included, with each offset mounting element of the plurality of offset mounting elements being configured for supporting the supported element in spaced relation with at least one of the first upright member, the second upright member, or at least one cross member of the plurality of cross members.

### CROSS-REFERENCE TO RELATED APPLICATIONS

This application claims the benefit of priority under 35 USC § 119(e) of U.S. Provisional Patent Application No. 63/737,354 filed December 20, 2024 and U.S. Provisional Patent Application No. 63/737,842 filed December 23, 2024. The contents of all applications referenced in this paragraph are incorporated into the present application by reference.

### FIELD OF THE INVENTION

The present disclosure relates generally to a frames for a cart or for a wall-mounted structure for supporting a variety of items. The disclosed frames may be incorporated into shadow boards, which are boards with outlines of tools indicating where each tool should be placed when not in use, or into washdown screens, knockdown carts, and the like for use in sanitary or critical controlled environments—for example, in food-processing plants and pharmaceutical-manufacturing plants. This invention relates more particularly to a sanitary frame or an anti-contamination frame for use in such an environment.

### BACKGROUND OF THE INVENTION

Shadow boards are traditionally used to provide organized storage for tools used in a variety of facilities, including manufacturing facilities. Often one or two shadow boards are supported on a movable shadow-board cart so that the shadow board, and the tools carried by the shadow board, may be conveniently moved about the manufacturing facility. Alternatively, shadow boards may be mounted to a wall or other fixed structure. Shadow boards may be used in manufacturing facilities that manufacture food or other products requiring a sanitary environment.

Knockdown carts or equipment-breakdown-disassembly carts are analogous to shadow boards and typically provide pre-marked or otherwise adapted locations for storing parts, tools, or other necessary items during the disassembly and assembly equipment, as may be performed during maintenance and sanitation such as clean-in-place or clean-out-of-place operations.

Washdown screens are used to provide a barrier (typically a temporary barrier) between two areas in a manufacturing facility, most commonly when one of the two areas is undergoing a washdown process, in order to block cleaning liquid and other matter from passing from the area undergoing washdown to an adjacent area.

Many facilities require the minimization of contamination, including contamination related to harborage of liquids trapped in or between elements of equipment. For example, in food-manufacturing facilities, it is necessary to maintain sanitary conditions. Other types of facilities may have requirements for maintaining sanitary conditions or otherwise avoiding contamination—for example, facilities manufacturing products or components for in the pharmaceutical, aerospace, or automotive fields, where “clean cooms” or critical controlled environments may be needed.

Devices according to the present disclosure may aid the user in maintaining sanitary of low-contamination conditions in a food-manufacturing facility or other facility by providing a sanitary frame for a cart or a fixed shadow board. Such a cart may be used for supporting and transporting supported element—for example, a shadow board (including but not limited to a shadow-board cart), a washdown screen; or where the frame may be used for a knockdown cart, a cart for quality-control operations, or the like. As disclosed herein, the frame of the cart, or of a fixed shadow board or the like, is specially configured to eliminate or to minimize the retention or harborage of trapped liquids, thereby limiting or eliminating bacterial growth and the creation of unsanitary conditions or sources of contamination.

### SUMMARY OF THE DISCLOSURE

Briefly stated, an example of sanitary frame for a supported element may include: an upright member having an upright-member cross section, wherein the upright-member cross section is open-shaped; a cross member having a cross-member cross section, wherein the cross-member cross section is open-shaped; and a plurality of offset mounting elements, offset mounting element of the plurality of offset mounting elements being configured for supporting the supported element in spaced relation with at least one of the first upright member, the second upright member, or at least one cross member of the plurality of cross members.

In any embodiment, a sanitary frame may further include: a second upright member having a second-upright-member cross section, wherein the second-upright-member cross section is open-shaped; a second cross member, the second cross-member having a second-cross-member cross section, wherein the second-cross-member cross section is open-shaped.

Any embodiment may include a sanitary frame wherein each offset mounting element of the plurality of offset mounting elements includes a hook extending outwardly from the upright member or the cross member, the hook being configured to support the supported element in spaced relation from the corresponding upright member or cross member.

Any embodiment may include a sanitary frame wherein each offset mounting element of the plurality of offset mounting elements includes a hook extending outwardly from the upright member, the second upright member, or the cross member, the hook being configured to support the supported element in spaced relation from the corresponding upright member, second upright member, or cross member.

In any embodiment, a sanitary frame may further include a shadow board or washdown screen supported by the offset mounting elements, the shadow board or washdown screen being air gapped from the first upright member and the cross member of the sanitary frame such that liquid is prevented from being trapped between the shadow board or washdown screen and the first upright member and the cross member of the sanitary frame.

In any embodiment, a sanitary frame may further include a shadow board or washdown screen supported by the offset mounting elements, wherein the shadow board or washdown screen is air gapped from the first upright member, the second upright member, and the cross member of the sanitary frame such that liquid is prevented from being trapped between the shadow board or washdown screen and the first upright member, the second upright member, and the cross member of the sanitary frame.

Any embodiment may include a sanitary frame, each cross member having first and second cross-mounting tabs at opposite ends thereof, with each cross member being attached in spaced relation to the first upright member and the second upright member by the first cross-mounting tab engaging the first upright member and the second cross-mounting tab engaging the second upright member.

In any embodiment, a sanitary frame may further include a first cross-member-attachment nut sealingly and permanently attached to the first cross-mounting tab; and a second cross-member-attachment nut sealingly and permanently attached to the second cross-mounting tab

In any embodiment, a sanitary frame may further include a freestanding base supporting the first upright member in a vertical orientation, the freestanding base including: a first base element and a second base element; and a transverse base member extending from the first base element to the second base element, the transverse base member having a transverse-base-member cross section, wherein the transverse-base-member cross section is open-shaped.

In any embodiment, a sanitary frame may further include a freestanding base supporting the first upright member and the second upright member in a vertical orientation, the freestanding base including: a first base element and a second base element; and a transverse base member extending from the first base element to the second base element, the transverse base member having a transverse-base-member cross section, wherein the transverse-base-member cross section is open-shaped.

Any embodiment may include a sanitary frame wherein the transverse base member has first and second base-mounting tabs at opposite ends thereof, with each transverse base member being attached in spaced relation to the first base element and the second base element by the first and second base-mounting tabs.

Any embodiment may include a sanitary frame wherein the transverse base member has first and second base-mounting tabs at opposite ends thereof, with each transverse base member being attached in spaced relation to the first base element and the second base element by the first and second base-mounting tabs.

In any embodiment, a sanitary frame may further include a first transverse-base-member-attachment nut being sealingly and permanently attached to the first base-mounting tab and the first base element; and a second transverse-base-member-attachment nuts being sealingly and permanently attached to the second base-mounting tab and the second base element.

In any embodiment, a sanitary frame may further include a first transverse-base-member-attachment nut being sealingly and permanently attached to the first base-mounting tab and the first base element; and a second transverse-base-member-attachment nuts being sealingly and permanently attached to the second base-mounting tab and the second base element.

Any embodiment may include a sanitary frame wherein the cross member has a cross-member cross section that defines a gap, and the gap is oriented downwardly when the sanitary frame is in a an upright orientation.

Any embodiment may include a sanitary frame wherein each cross member has a cross-member cross section that defines a gap, and the gap is oriented downwardly when the sanitary frame is in a an upright orientation.

Any embodiment may include a sanitary frame wherein each cross-member-attachment nut includes a self-clinching nut fixed to a corresponding cross-mounting tab.

In any embodiment, a sanitary frame or any one, wherein each cross-mounting tab includes rounded or curved edges configured to reduce liquid harborage at a junction between the cross member and one of the first upright member or the second upright member.

In any embodiment, a sanitary frame may include casters attached to the freestanding base.

In any embodiment, a sanitary frame may further include a freestanding base supporting the first upright member and the second upright member in a vertical orientation, the freestanding base including: a first base element and a second base element; and a transverse base member extending from the first base element to the second base element, the transverse base member having a transverse-base-member cross section, wherein the transverse-base-member cross section is open-shaped, the transverse base member having first and second base-mounting tabs at opposite ends thereof, with each transverse base member being attached in spaced relation to the first base element and the second base element by first and second transverse-base-member-attachment nuts, the first transverse-base-member-attachment nut being sealingly and permanently attached to the first base-mounting tab and the first base element, and the second transverse-base-member-attachment nuts being sealingly and permanently attached to the second base-mounting tab and the second base element.

Any embodiment may include a sanitary frame wherein the first upright member and the cross member are air-gapped at a distance of at least 0.25 inch or 0.64 cm at all locations other than where the first cross-member-attachment nut connects the first upright member to the cross member.

Any embodiment may include a sanitary frame wherein the first upright member and the cross member are air-gapped at a distance of at least 0.5 inch or 1.3 cm at all locations other than where the first cross-member-attachment nut connects the first upright member to the cross member.

Any embodiment may include a sanitary frame wherein the supported element is a shadow board.

Any embodiment may include a sanitary frame wherein the supported element is a washdown screen.

Any embodiment may include a sanitary frame wherein the offset mounting member includes at least one of a hook, an offset mount, a cylindrical spacer, or a non-cylindrical spacer.

Any embodiment may include a sanitary frame wherein the offset mount comprises: a projection extending outwardly from the upright member or the cross member; and an offset tab extending transversely from the projection and oriented generally parallel to the upright member or the cross member.

Embodiments of the disclosed sanitary frame include a sanitary frame according to the flowing clauses.

Clause 1. A sanitary frame for a supported element, the sanitary frame comprising: an upright member having an upright-member cross section, wherein the upright-member cross section is open-shaped; a cross member having a cross-member cross section, wherein the cross-member cross section is open-shaped; and a plurality of offset mounting elements, offset mounting element of the plurality of offset mounting elements being configured for supporting the supported element in spaced relation with at least one of the first upright member, the second upright member, or at least one cross member of the plurality of cross members.

Clause 2. The sanitary frame of clause 1, further comprising: a second upright member having a second-upright-member cross section, wherein the second-upright-member cross section is open-shaped; a second cross member, the second cross-member having a second-cross-member cross section, wherein the second-cross-member cross section is open-shaped.

Clause 3. The sanitary frame of any preceding clause, wherein each offset mounting element of the plurality of offset mounting elements comprises a hook extending outwardly from the upright member or the cross member, the hook being configured to support the supported element in spaced relation from the corresponding upright member or cross member.

Clause 4. The sanitary frame of clause 2 or any preceding clause, wherein each offset mounting element of the plurality of offset mounting elements comprises a hook extending outwardly from the upright member, the second upright member, or the cross member, the hook being configured to support the supported element in spaced relation from the corresponding upright member, second upright member, or cross member.

Clause 5. The sanitary frame of any preceding clause, further comprising a shadow board or washdown screen supported by the offset mounting elements, the shadow board or washdown screen being air gapped from the first upright member and the cross member of the sanitary frame such that liquid is prevented from being trapped between the shadow board or washdown screen and the first upright member and the cross member of the sanitary frame.

Clause 6. The sanitary frame of clause 2 or any preceding clause, further comprising a shadow board or washdown screen supported by the offset mounting elements, wherein the shadow board or washdown screen is air gapped from the first upright member, the second upright member, and the cross member of the sanitary frame such that liquid is prevented from being trapped between the shadow board or washdown screen and the first upright member, the second upright member, and the cross member of the sanitary frame.

Clause 7. The sanitary frame of clause 2 or any preceding clause, each cross member having first and second cross-mounting tabs at opposite ends thereof, with each cross member being attached in spaced relation to the first upright member and the second upright member by the first cross-mounting tab engaging the first upright member and the second cross-mounting tab engaging the second upright member.

Clause 8. The sanitary frame of clause 7, further comprising: a first cross-member-attachment nut sealingly and permanently attached to the first cross-mounting tab; and a second cross-member-attachment nut sealingly and permanently attached to the second cross-mounting tab

Clause 9. The sanitary frame of any preceding clause, further comprising a freestanding base supporting the first upright member in a vertical orientation, the freestanding base including: a first base element and a second base element; and a transverse base member extending from the first base element to the second base element, the transverse base member having a transverse-base-member cross section, wherein the transverse-base-member cross section is open-shaped.

Clause 10. The sanitary frame of clause 2 or any preceding clause, further comprising a freestanding base supporting the first upright member and the second upright member in a vertical orientation, the freestanding base including: a first base element and a second base element; and a transverse base member extending from the first base element to the second base element, the transverse base member having a transverse-base-member cross section, wherein the transverse-base-member cross section is open-shaped.

Clause 11. The sanitary frame of clause 9, wherein the transverse base member has first and second base-mounting tabs at opposite ends thereof, with each transverse base member being attached in spaced relation to the first base element and the second base element by the first and second base-mounting tabs.

Clause 12. The sanitary frame of clause 10, wherein the transverse base member has first and second base-mounting tabs at opposite ends thereof, with each transverse base member being attached in spaced relation to the first base element and the second base element by the first and second base-mounting tabs.

Clause 13. The sanitary frame of clause 11, further comprising: a first transverse-base-member-attachment nut being sealingly and permanently attached to the first base-mounting tab and the first base element; and a second transverse-base-member-attachment nuts being sealingly and permanently attached to the second base-mounting tab and the second base element.

Clause 14. The sanitary frame of clause 12, further comprising: a first transverse-base-member-attachment nut being sealingly and permanently attached to the first base-mounting tab and the first base element; and a second transverse-base-member-attachment nuts being sealingly and permanently attached to the second base-mounting tab and the second base element.

Clause 15. The sanitary frame of any preceding clause, wherein the cross member has a cross-member cross section that defines a gap, and the gap is oriented downwardly when the sanitary frame is in a an upright orientation.

Clause 16. The sanitary frame of clause 2 or any preceding clause, wherein each cross member has a cross-member cross section that defines a gap, and the gap is oriented downwardly when the sanitary frame is in a an upright orientation.

Clause 17. The sanitary frame of clause 8 or any one of clauses 9 through16, wherein each cross-member-attachment nut comprises a self-clinching nut fixed to a corresponding cross-mounting tab.

Clause 18. The sanitary frame of clause 8 or any one of clauses 10 through 16, wherein each cross-mounting tab includes rounded or curved edges configured to reduce liquid harborage at a junction between the cross member and one of the first upright member or the second upright member.

Clause 19. The sanitary frame of clause 9 or any one of clauses 9 through 18, further comprising casters attached to the freestanding base.

Clause 20. The sanitary frame of any preceding clause, further comprising a freestanding base supporting the first upright member and the second upright member in a vertical orientation, the freestanding base including: a first base element and a second base element; and a transverse base member extending from the first base element to the second base element, the transverse base member having a transverse-base-member cross section, wherein the transverse-base-member cross section is open-shaped, the transverse base member having first and second base-mounting tabs at opposite ends thereof, with each transverse base member being attached in spaced relation to the first base element and the second base element by first and second transverse-base-member-attachment nuts, the first transverse-base-member-attachment nut being sealingly and permanently attached to the first base-mounting tab and the first base element, and the second transverse-base-member-attachment nuts being sealingly and permanently attached to the second base-mounting tab and the second base element.

Clause 21. The sanitary frame of any preceding clause, wherein the first upright member and the cross member are air-gapped at a distance of at least 0.25 inch or 0.64 cm at all locations other than where the first cross-member-attachment nut connects the first upright member to the cross member.

Clause 22. The sanitary frame of any preceding clause, wherein the first upright member and the cross member are air-gapped at a distance of at least 0.5 inch or 1.3 cm at all locations other than where the first cross-member-attachment nut connects the first upright member to the cross member.

Clause 23. The sanitary frame of any preceding clause, wherein the supported element is a shadow board.

Clause 24. The sanitary frame of any preceding clause, wherein the supported element is a washdown screen.

Clause 25. The sanitary frame of any preceding clause, wherein the offset mounting member includes at least one of a hook, an offset mount, a cylindrical spacer, or a non-cylindrical spacer.

Clause 26. The sanitary frame of any preceding clause, wherein the offset mount comprises: a projection extending outwardly from the upright member or the cross member; and an offset tab extending transversely from the projection and oriented generally parallel to the upright member or the cross member.

### BRIEF DESCRIPTION OF THE SEVERAL VIEWS OF THE DRAWINGS

The following description will be better understood when read in conjunction with the appended drawings. It should be understood, however, that the invention is not limited to the precise arrangements and instrumentalities shown. In the drawings:

FIG. 1 is perspective view of a sanitary frame for a cart according to the present disclosure;

FIG. 2A is a partial front elevational view of the sanitary frame of FIG. 1;

FIGS. 2B-2E are detail views of the sanitary frame of FIG. 1, as indicated in FIG. 2A;

FIGS. 2F-2G are detail views of the sanitary frame of FIG. 1;

FIG. 3A is a partial front elevational view of the sanitary frame of FIG. 1;

FIG. 3B is a side elevational view of the sanitary frame of FIG. 1;

FIG. 3C is a detail view of the sanitary frame of FIG. 1, as indicated in FIG. 3A;

FIG. 4A is a partial side elevational view of the sanitary frame of FIG. 1;

FIGS. 4B and 4C are detail views of the frame of FIG. 1, as indicated in FIG. 4A;

FIGS. 5A is a perspective view of a base element of the frame of FIG. 1;

FIG. 5B is an elevational view of a flat element used in making the base element of FIG. 5A;

FIG. 5C is a top plan view of the base element of FIG. 5A;

FIG. 5D is a front elevational view of the base element of FIG. 5A;

FIG. 5E is a side elevational view of the base element of FIG. 5A;

FIGS. 6A is a perspective view of a transverse base member of the frame of FIG. 1;

FIG. 6B is a view of a flat element formed in making the transverse base member FIG. 6A;

FIG. 6C is a top plan view of the transverse base member FIG. 6A;

FIG. 6D is a detail view of the transverse base member FIG. 6A;

FIG. 7A is a perspective view of an upright member of the frame of FIG. 1;

FIG. 7B is a side elevational view of the upright member of FIG. 7A;

FIG. 7C is a front elevational view of the upright member of FIG. 7A;

FIG. 7D is a detail view of the upright member of FIG. 7A, as indicated in FIG. 7C;

FIGS. 7E is a top plan view of the upright member of FIG. 7A;

FIG. 8A is a plan view of a flat element used in making the upright member of FIG. 7A, shown in a rotated orientation;

FIG. 8B is a detail view of the flat element of FIG. 8A;

FIG. 9A is a perspective view of a cross member of the frame of FIG. 1;

FIG. 9B is a plan view of a flat element used in making the cross member of FIG. 9A;

FIG. 9C is a side elevational view of the cross member of FIG. 9A;

FIG. 9D is a top plan view of the cross member of FIG. 9A;

FIG. 9E is a front elevational view of the cross member of FIG. 9A;

FIG. 10 is a perspective view of an alternative sanitary cart carrying a washdown screen;

FIGS. 11A is a perspective views of a cart employing a sanitary frame similar to the sanitary frame of FIG. 1;

FIGS. 11B is a partial perspective views of the cart of FIG. 11A;

FIG. 12A is a perspective view of a second embodiment of cart having a frame similar to the frame of FIG. 1, but with a different fixation means for supporting the supported element;

FIGS. 12B and 12C are detail views of the cart of FIG. 12A;

FIG. 13A is a perspective view of a frame for attachment to a wall or other structure, in accord with the present disclosure; and

FIG. 13B is a detail view of the frame of FIG. 13A.

### DETAILED DESCRIPTION

Certain terminology is used in the following description for convenience only and is not limiting. As used herein, the term “self-clinching nut” refers to a type of permanently installed nut configured to be press-fit or rotated and driven into a host sheet or plate of a ductile material (such as a ductile sheet metal), or other host material of appropriate characteristics, including ductility and hardness, such that material of the host engages the self-clinching nut (for example, plastically flows into a recess, undercut, or other clinching feature of the self-clinching nut) to secure the self-clinching nut to the sheet or plate. Upon installation, the host material mechanically locks the fastener against axial and rotational displacement, thereby providing a durable internally threaded attachment point within the host material. Commercial examples of self-clinching nuts include products sold under the PEM® brand, although the term “self-clinching nut” as used herein is not limited to any particular manufacturer.

The words “right,” “left,” “lower,” and “upper” designate directions in the drawings to which reference is made. The words “inner” and “outer” refer to directions toward and away from, respectively, the geometric center of an object and designated parts thereof. Unless specifically set forth otherwise herein, the terms “a,” “an,” and “the” are not limited to one element but instead should be read as meaning “at least one.” “At least one” may occasionally be used for clarity or readability, but such use does not change the interpretation of “a,” “an,” and “the.” Moreover, the singular includes the plural, and vice versa, unless the context clearly indicates otherwise. “Including” as used herein means “including but not limited to.” The word “or” is inclusive, so that “A or B” encompasses A and B, A only, and B only. The terms “about,” “approximately,” “generally,” “substantially,” and like terms used herein, when referring to a dimension or characteristic of a component, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit thereof. The terminology set forth in this paragraph includes the words noted above, derivatives thereof and words of similar import.

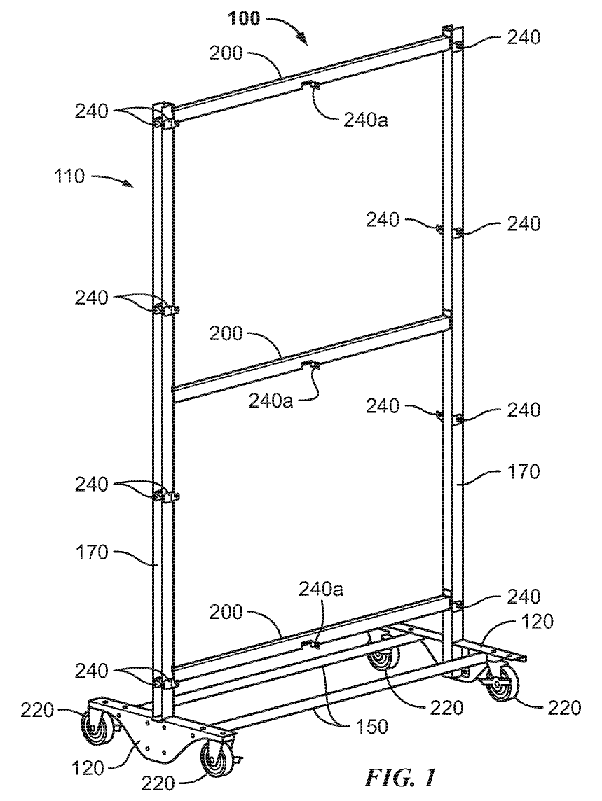

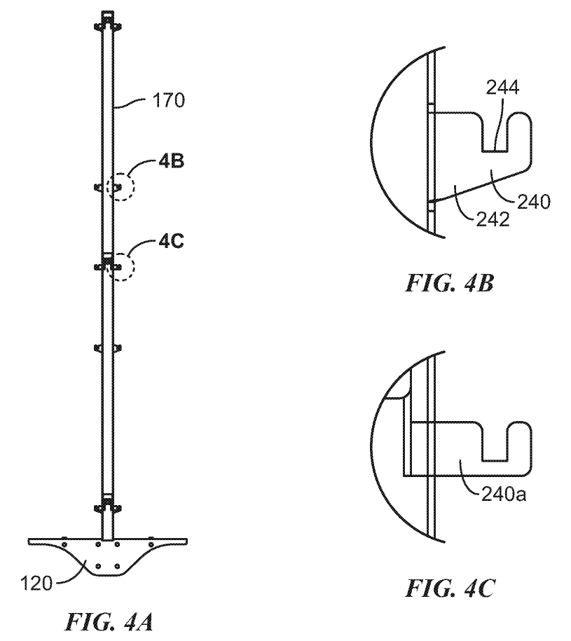

Referring to the drawings in detail, wherein like numerals indicate like elements throughout, there is shown in FIGS. 1-11B an embodiment of a sanitary frame for a supported element, in accordance with the present disclosure.

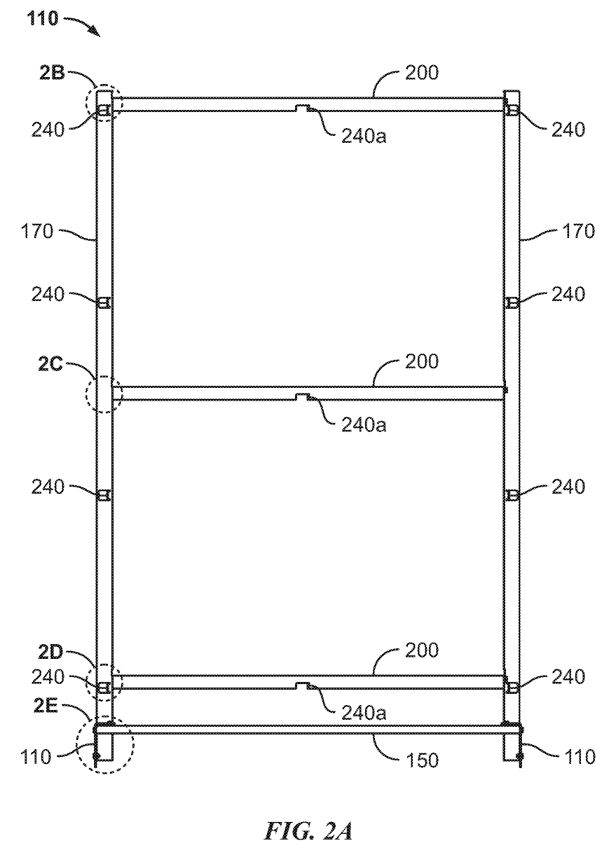

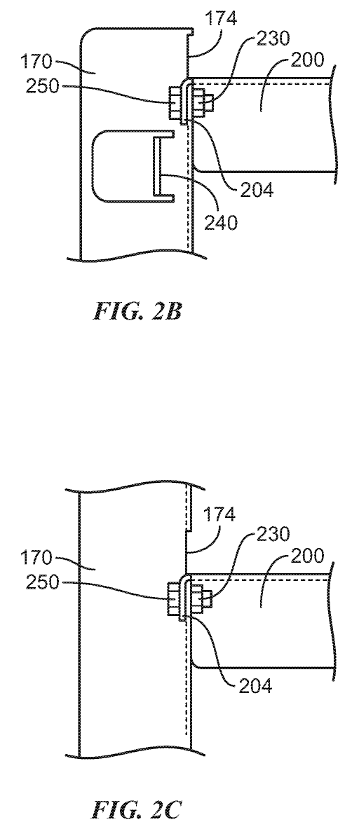

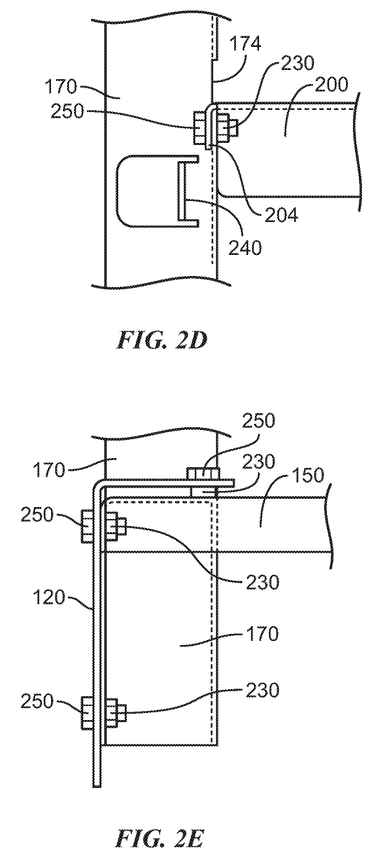

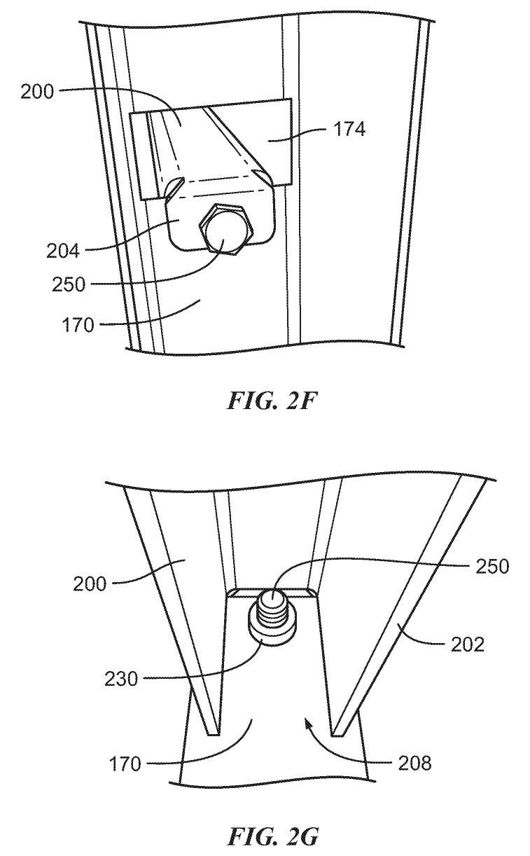

FIG. 1 illustrates a sanitary cart 100 including a sanitary frame 110. The sanitary frame 110 in shown in detail in FIGS. 2A-9E. The sanitary frame 110 is configured for supporting a supported element, such as a shadow board, a washdown screen, a platform of a knockdown cart, a work surface for a quality-control cart, or the like. The sanitary frame 110 may be supported on rolling elements such as casters 220, wheels, or the like. As noted above, the sanitary frame 110 includes various features configured to aid the user in maintaining a sanitary environment where the frame is used. The features include at least the cross-sectional shape of various elements and the manner of mounting the shadow board, washdown screen, platform of a knockdown cart, work surface for a quality control cart, or the like to the sanitary frame. The features may include the manner of connection of the frame elements to support such elements in spaced relation to one another. The sanitary frame 110 includes a freestanding base, which as illustrated includes a base element 120 (two are shown) on each lateral side of the sanitary frame 110. The illustrated example of the freestanding base also includes a transverse base member 150 (two are shown) extends between and connects the base elements 120 to form a base for the sanitary frame 110.

In the illustrated examples, two upright members 170 are supported by the freestanding base and the base elements 120 thereof in a vertical orientation, in parallel and spaced relation to one another. Alternatively, a single upright member may be employed, with each base element 120 being connected to the single upright member at a single location. In the illustrated examples, each upright member 170 is secured in spaced relation with respect to one of the base elements 120. In the illustrated examples, the upright member 170 (or the upright member 1170) is air-gapped with respect to the cross-members 200 or the cross members 2300 which are attached thereto, with contact between the first upright member and the cross member being only indirect via the first cross-member-attachment nut. Each upright member 170 may be air-gapped at a distance of at least 0.25 inch (0.64 cm) or at least 0.5 inch (1.3 cm) from the base element 120. Cross members 200 extend between the upright members 170 and are connected to the upright members 170 as described below. Offset mounting elements such as hooks 240 or alternative hooks 240a or one or more offset mounts 2240 (discussed further below) or cylindrical spacers or spacers of any shape (for example, washers or blocks) for passing a bolt, screw, or other fastener therethrough, may be provided on the upright members 170 or on the cross members 200 (or on both) and may support a shadow board or wash screen, with the shadow board or wash screen being air-gapped from the upright members 170, the cross members 200, or other frame members to which the shadow board or wash screen is attached at a distance of at least 0.25 inch (0.64 cm) or at least 0.5 inch (1.3 cm).

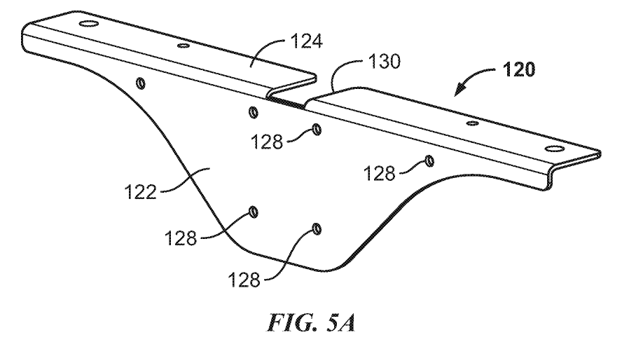

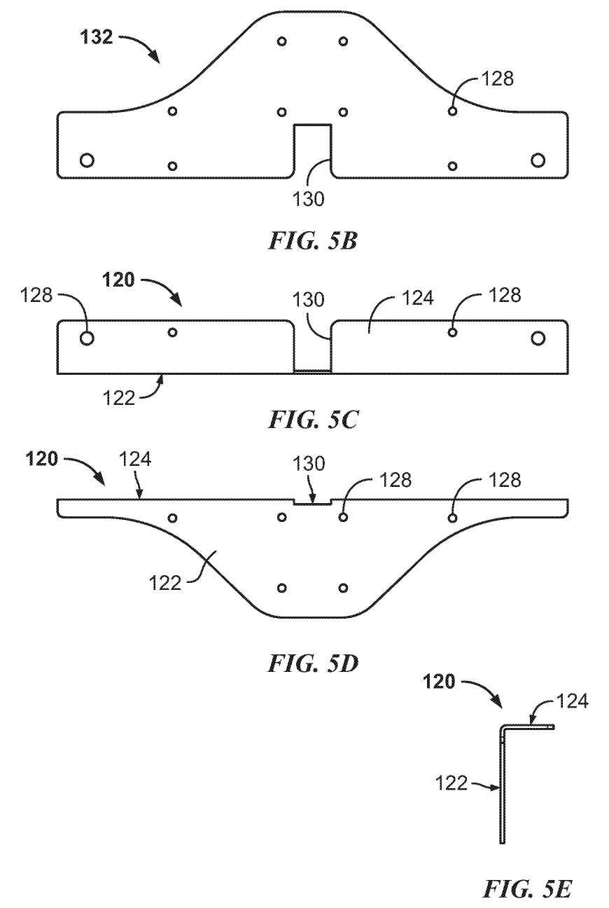

Each base element 120 is now considered in detail, with reference to FIGS. 5A-5E. In the illustrated example, each base element 120 includes a vertical plate 122 and a horizontal plate 124. The vertical plate 122 and the horizontal plate 124 may be formed by bending a suitable flat element 132 (FIG. 5B) of metal, or by other methods as known in the art. The vertical plate 122 includes a plurality of bolt holes 128 for securing the upright members 170 thereto. The vertical plate 122 and the horizontal plate 124 may include a plurality of bolt holes 128 for securing the transverse base members 150 to the base elements 120. The horizontal plate 124 may include holes 128 for attaching casters 220 (FIG. 1), other rolling elements, or non-rolling support elements such skids or rails (not shown). Each base element 120 may include a slot 130 for accommodating an upright member 170 for attachment to the base element 120.

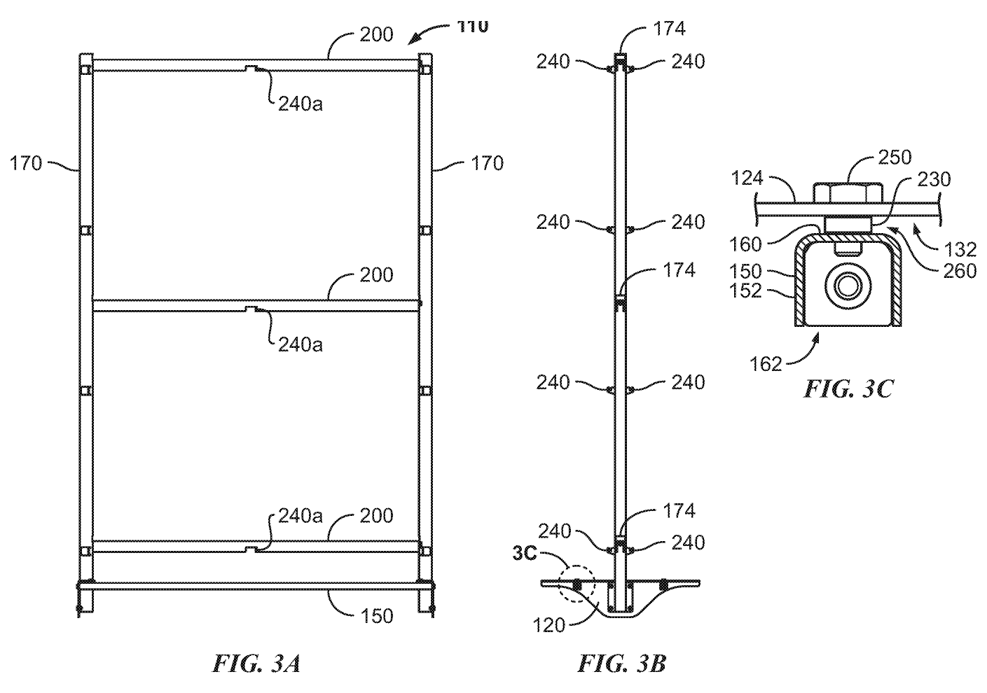

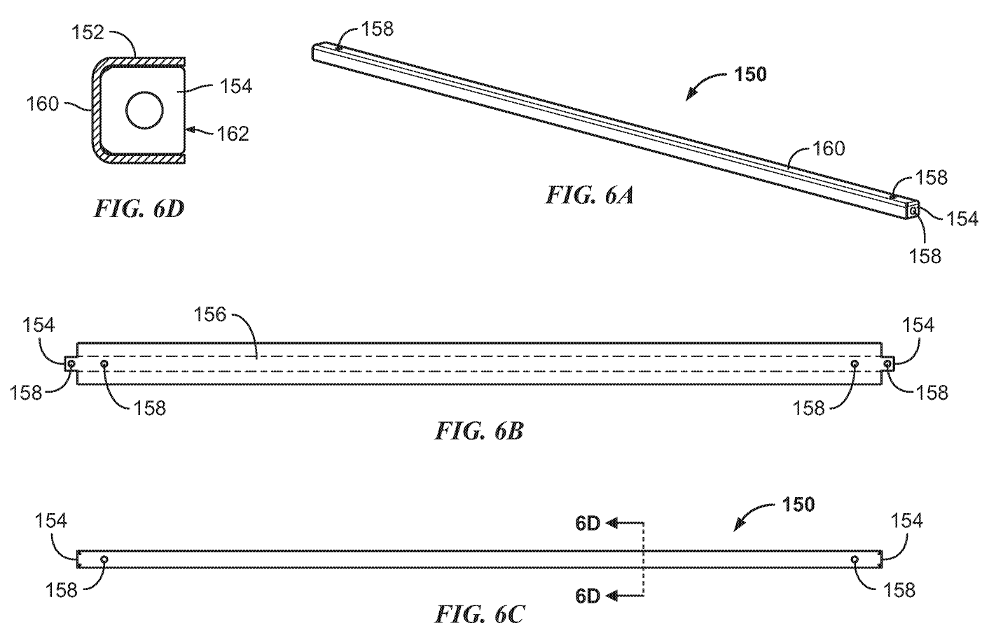

Referring to FIGS. 3C and 6A through 6D, each transverse base member 150 of the freestanding base has a transverse-base-member cross-sectional shape (see FIG. 6D) that is either an open shape such as an L-shape or is an open shape formed from a closed shape such as a rectangular cross section 152 (which may have rounded corners), with a portion thereof omitted to form a gap 162 in the closed shape. The gap 162 (or any gap in a member disclosed herein) preferably may comprise an opening of at least 0.5 percent, 1 percent, 3 percent, 5 percent, or 10 percent of the perimeter of the closed shape.

In the illustrated examples, each transverse base member 150 is formed from a flat element 156 illustrated in FIG. 6B. To form the transverse base member 150, a flat element 156 may be bent so that the transverse base member 150 has the cross section of a rectangle with one side missing (sometimes identified as a downward-facing U-shape) in a mounted configuration. First and second base-mounting tabs in the form of base-mounting tabs 154 at opposite ends of the transverse base member 150 are bent to extend downwardly from an upper portion of the U-shape at each end of the transverse base member 150. In an alternative embodiment, each transverse base member 150 may be formed of a solid body (as opposed to a tubular body) with base-mountings 154 attached thereto.

Each base-mounting tab 154 has a hole 158 and has first transverse-base-member attachment nut or a second transverse-base-member-attachment nut in the form of a sealingly and permanently attached nut, such as a welded nut or a self-clinching nut 230, as defined above, inserted into or fixed thereto. Each base-mounting tab 154 may extend downwardly and may be shaped with curved edges to minimize any pinch point that might otherwise tend to retain liquid. A sealingly and permanently attached nut is in contrast to a standard nut that is threadedly engaged with a bolt and can be removed by rotating the nut in standard fashion. Instead, the sealingly and permanently engaged nut remains in place fixed to a corresponding element such as the base-mounting tab 154. Although a nut (or alternatively a spacer) that is not sealingly and permanently attached may be used, a sealingly and permanently attached nut provides the advantage of preventing harborage of liquid and eliminating the possibility of a nut becoming loose and falling into a product, causing contamination, an unsanitary condition, or other damage. A bolt 250 extends generally horizontally and engages each transverse base member 150 by being inserted through a hole 128 in the transverse base member 150, through a hole 158 in a base-mounting tab 154 of the transverse base member 150, and into the sealingly attached nut, such as the illustrated self-clinching nut 230, the self-clinching nut 230 being fixed to the base-mounting tab 154. A spacer may by substituted for the self-clinching nut 230.

Referring to FIGS. 6A through 6C, each end of each transverse base member 150 also has an upper surface 160 (or an upper surface portion) including a hole 158 near each end of the transverse base member 150. Each hole 158 in the upper surface 160 of the transverse base member 150 may be employed in fixing the transverse base member 150 to the horizontal plate 124 of the base element 120. The upper surface 160 and has a sealingly attached nut, such as a self-clinching nut 230, inserted in alignment with the hole 158. A bolt 250 is inserted through the bolt hole 128 of the horizontal plate 124 and into engagement with the sealingly attached nut 230 of the upper surface 160 of the transverse base member 150, thus securing the transverse base member 150 to the horizontal plate 124 of the sanitary frame 110 in spaced relation thereto. In each junction employing a sealingly attached nut such as the bolt 250, any two members of the base element 120, the transverse base member 150, the upright member 170, or the cross member 200 (as discussed below) are mutually joined in spaced relation, creating a space or an air gap 260 between such elements, the space being bridged only by one or more of the sealingly attached nut(s) 230. Such elements may be said to be “air gapped” at a specified minimum distance. See FIG. 3C, showing an example of an air gap 260 bridged by only a sealingly and permanently attached nut, such as a welded nut or a self-clinching nut 230. The disclosed arrangement may result in elimination of 90 percent, 95 percent, 98 percent, 99 percent or more of the length or contact area of sandwich points between frame elements, as compared to typical carts formed by fastening or welding frame elements together without use of the disclosed structure. The self-clinching nuts 230 may be configured to maintain a minimum gap 260 size of about 0.25 or 0.5 inches (0.64 cm or 1.3 cm) at points other than where the gap 260 is bridged by the self-clinching nuts 230. Similarly, a junction between a base-mounting tab 154 of a transverse base member 150 or a cross-mounting tab 204 of a cross member 200 and an upright member 170 may include an air gap as well. The disclosed arrangement minimizes the surface area in contact between the various elements and the adjacent pinch point, thus reducing or eliminating the opportunity for liquid to be retained at the junction.

The presently disclosed arrangement contrasts with the common arrangement of using an ordinary bolt securing the transverse base member 150 in contact with the base element 120, where the transverse base member 150 and the base element 120 are not held in spaced relation but instead form a pinch point along a substantial contact length on both the transverse base member 150 and the base element 120. As a result, the common arrangement forms a larger contact area and a longer or larger pinch point (compared to the presently disclosed sanitary frame 110). As a result, the presently disclosed sanitary frame 110 avoids retaining liquid and greatly reduces retained liquid compared to the common arrangement, is easier to clean, and is less likely to cause or contribute to an unsanitary condition than a frame of the common arrangement.

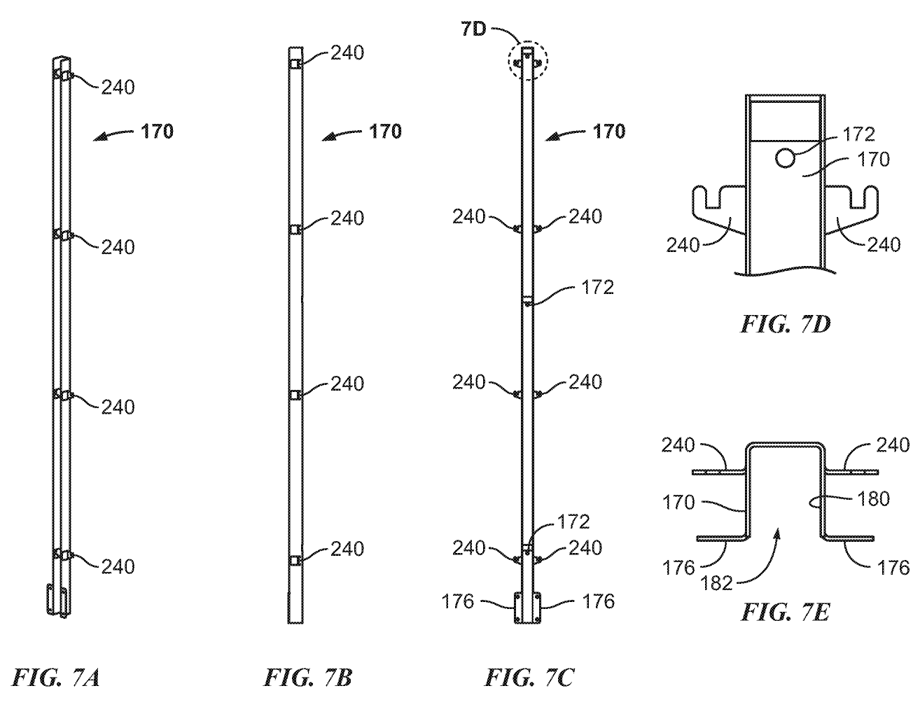

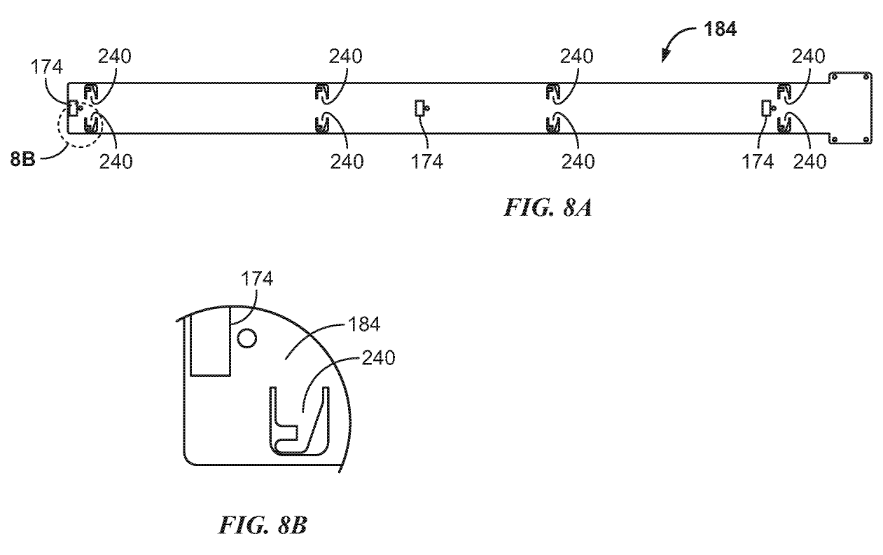

Referring to FIGS. 3A through 3C and 7A through 7E, each upright member 170 is configured for attachment to a base element 120. The upright member 170 may be formed by bending a suitable flat element 184 (FIGS. 8A and 8B) of metal, or by other methods as known in the art. Each upright member 170 extends upwardly in the illustrated embodiments and may be straight or may alternatively include bends or angles as needed for the intended application. In the illustrated examples, the upright member 170 has a pair of mounting plates 176 extending therefrom. Each mounting plate has two holes 178, with a sealingly and permanently attached nut, such as a self-clinching nut 230, inserted into or fixed to the upright member 170 in alignment with a corresponding hole 178. The disclosed arrangement allows each upright member 170 to be secured to a base element 120 in spaced relation thereto and air-gapped with respect thereto and may be air-gapped at a distance of at least 0.25 inch (0.64 cm) or at least 0.5 inch (1.3 cm) with respect thereto. As with the connection of the transverse base member 150 to the base element 120, the disclosed connection of the upright member 170 to the base element 120 minimizes the amount of surface area in contact and/or the size or length of any pinch point between the upright member 170 and the base element 120, thus reducing or eliminating the opportunity for liquid to be retained at the junction of the upright member 170 and the base element 120.

As noted above with respect to the connection of the transverse base member 150 to the base element 120, this arrangement contrasts with the common arrangement of using an ordinary bolt to secure the upright member 170 in contact with the base element 120, thus forming a larger contact area and a larger or longer pinch point (compared to the presently disclosed sanitary frame). As a result, the presently disclosed sanitary frame 110 avoids retaining liquid, is easier to clean, and is less likely to cause or contribute to an unsanitary condition than the common arrangement.

Moreover, referring to FIG. 7E, each upright member 170 also has an upright-member cross section 180 that is an open shape and is generally U-shaped with a gap 182 as described above. The gap 182 may be oriented laterally outwardly with respect to the sanitary frame 110 to ease cleaning of interior portions thereof. Alternatively, the upright member 170 may be solid. In any event, the upright member 170 may have hooks, tabs, and the like affixed thereto as needed. The presently disclosed sanitary frame 110, and the upright member 170 thereof, avoids trapping liquid, is easier to clean, and is less likely to cause or contribute to an unsanitary condition than the common arrangement of tubular frame elements joined by fasteners.

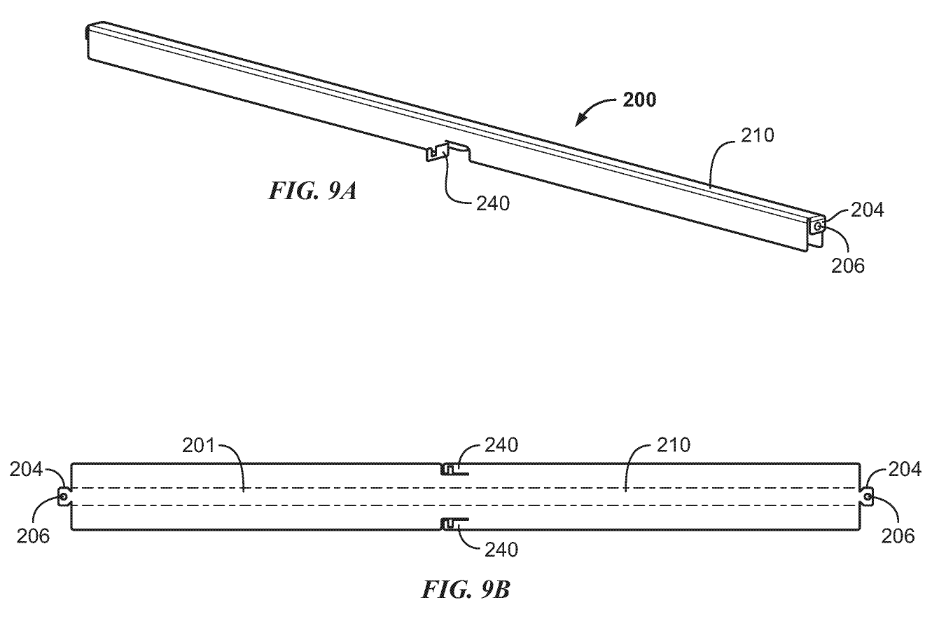

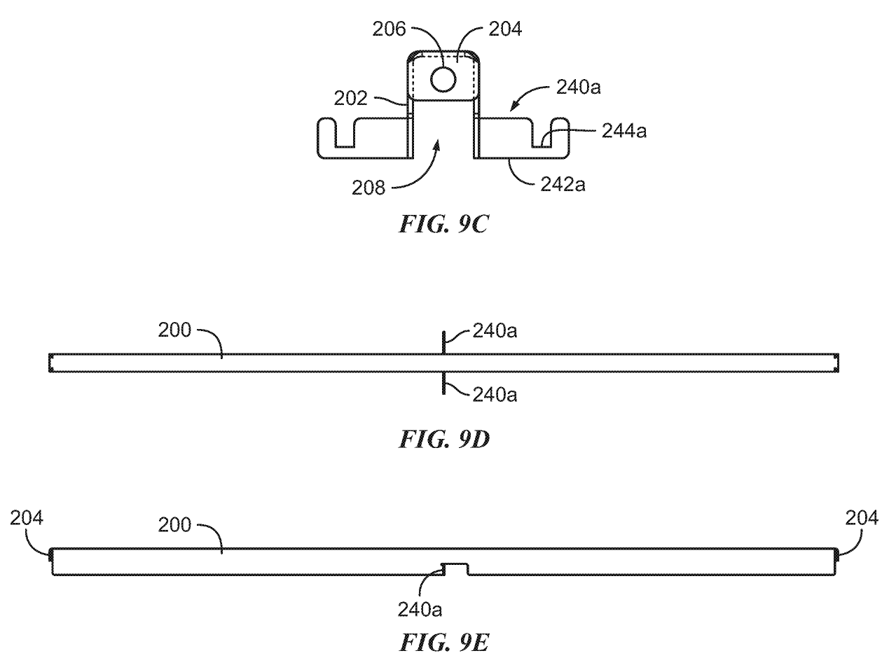

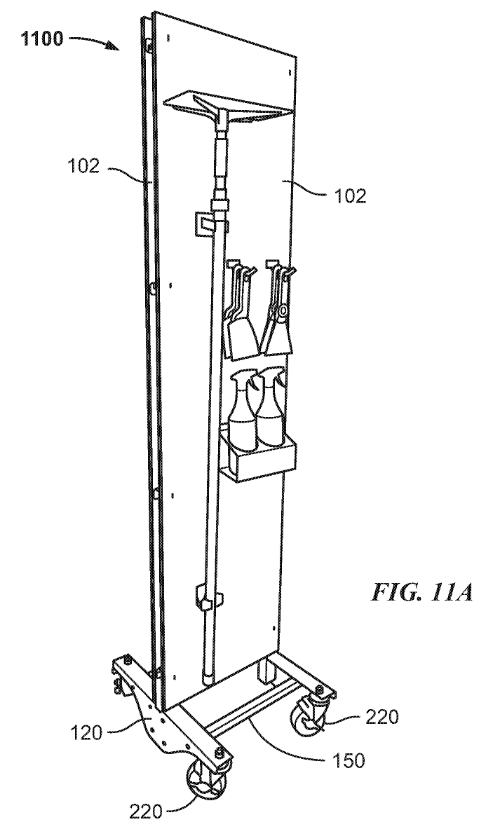

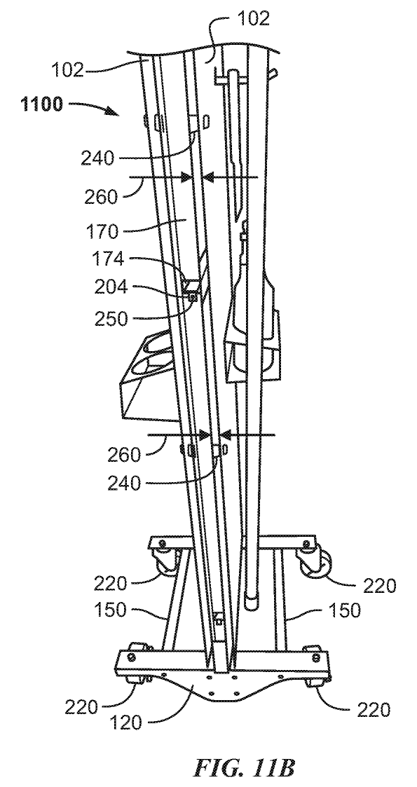

Referring to FIGS. 1, 3A-3C, and 7A-7C, each upright member 170 may include, and as illustrated includes, hooks 240 extending forwardly and rearwardly therefrom, so that the sanitary frame 110 may support two shadow boards or washdown screens facing forward and rearward with respect to the sanitary frame 110. Referring to FIG. 9C, a detail view of a hook 240a on a cross member 200, each hook 240a is configured with an arm 242a extending outwardly from the upright member 170 and a crook 244a to engage a supported element such as a shadow board 102 or a washdown screen 104 so that the shadow board(s) 102 (FIGS. 11A and 11B) or washdown screen 104 is supported at a distance and air-gapped from the surfaces of the upright member 170 (and may be air-gapped at a distance of at least 0.25 inch (0.64 cm) or at least 0.5 inch (1.3 cm)), with an air gap 260 bridged by only a hook 240, or an offset mount 2240. The hooks 240 may be formed by cutting or otherwise forming the hood 240 in the upright member 170 or the cross member 200 at the desired location, and then bending the hook 240 to extend outwardly from the upright member 170 or the cross member 200. Alternatively, the hooks 240 may be formed separately and affixed to the upright member 170 or the cross member 200.

Referring to FIGS. 1-3A and 9A-9E, the sanitary frame 110 includes at least one cross member 200, of which three are shown in the illustrated embodiment. Each cross member 200 has a cross-member cross section that may be, as shown, an open-shaped cross section in the form of rectangular cross section 202 with a gap 208 at the bottom forming an inverted U-shape in a mounted configuration. Alternatively, the cross-member cross section of the cross member 200 may be any tubular cross section, such as a round cross section, but with a gap, with the gap preferably being located at the lower side of the cross member 200 in a mounted configuration. Still further alternatively, the cross section of the cross member 200 could be solid, with tabs and hooks affixed as needed.

The cross member 200 may be formed from a flat element 201 (FIG. 9B), which may be bent to form a top portion 210. Each end of each cross member 200 has first and second cross-mounting tabs 204 at opposite ends thereof. Each cross-mounting tab 204 may extend downwardly and may be shaped with curved edges (see FIG. 9B) to minimize any pinch point that might otherwise tend to retain liquid. Each cross-mounting tab 204 has a hole 206. In the illustrated embodiment, at each point of connection between the cross member 200 and an upright member 170, the upright member 170 includes a bolt hole 172 and a tab slot 174. Each cross-mounting tab 204 has a first cross-member-attachment nut or a second cross-member-attachment nut attached thereto. The first and second cross-member-attachment nuts may each take to the form of a sealingly and permanently attached nut, such as a welded nut or a self-clinching nut 230, inserted into or fixed to the upright member 170 in correspondence with the bolt hole 172. The cross-mounting tab 204 at an end of the cross member 200 includes a hole 206, which is alignable with the hole 172 when the cross-mounting tab 204 hooks in the tab slot 174, with the cross-mounting tab 204 extending to an exterior side of the upright member 170. The cross member 200 thus is vertically fixed with respect to the upright member 170 by the cross-mounting tab 204 in spaced relation to the upright member 170 and is air-gapped with respect to the upright member 170 and may be air-gapped at a distance of at least 0.25 inch (0.64 cm) or at least 0.5 inch (1.3 cm). A bolt 250 is inserted through each bolt hole 172 and through each sealingly attached nut such as the self-clinching nut 230.

As noted above, the presently disclosed arrangement contrasts with an ordinary tubular frame member, which would have a closed-shaped cross section and typically have a cap at each end with a mounting hole in the cap, thus forming a closed tubular shape with a mounting hole at each end thereof. The presently disclosed configuration does not form a harborage for retaining liquid, whereas an ordinary tubular frame member, having a cap at each end, tends to admit and retain liquid, promoting potential growth of bacteria and potential creation a month and unsanitary conditions.

Referring to FIGS. 1, 10, and 11A-11B, a sanitary frame 110 may be supported by rolling supports such as casters 220 to form a sanitary cart 1100 for a shadow board or a washdown screen that is particularly well suited for use in a food-processing or other sanitary manufacturing facility due to the advantages of the sanitary frame disclosed herein.

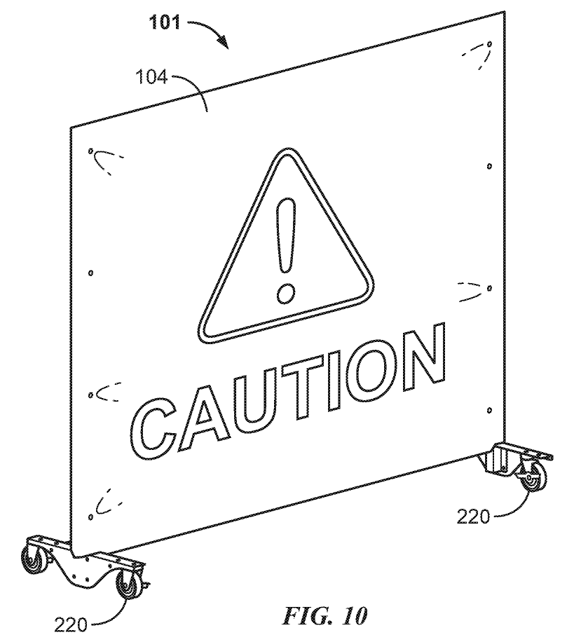

Referring to FIG. 10, a sanitary frame may be supported by rolling supports such as casters 220 to form a sanitary cart 101 for a washdown screen 104 that is particularly well suited for use in a food-processing or other sanitary manufacturing facility.

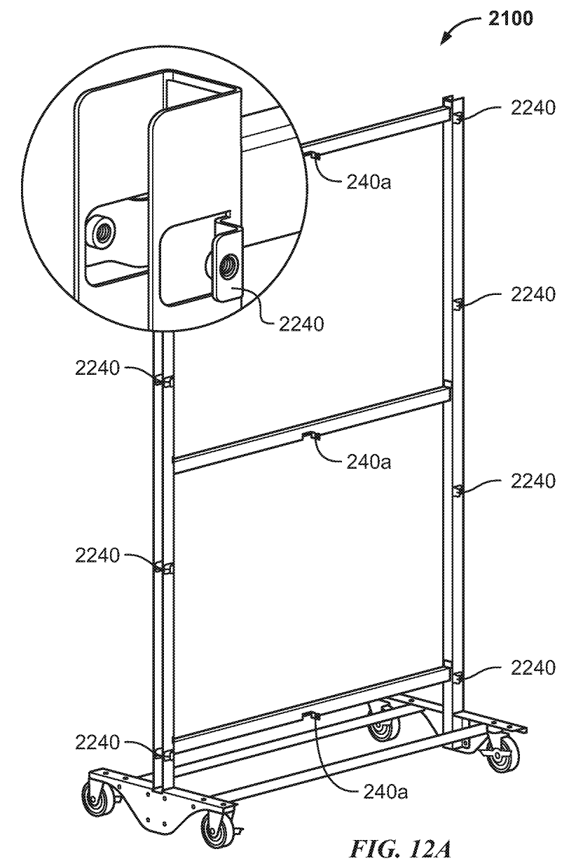

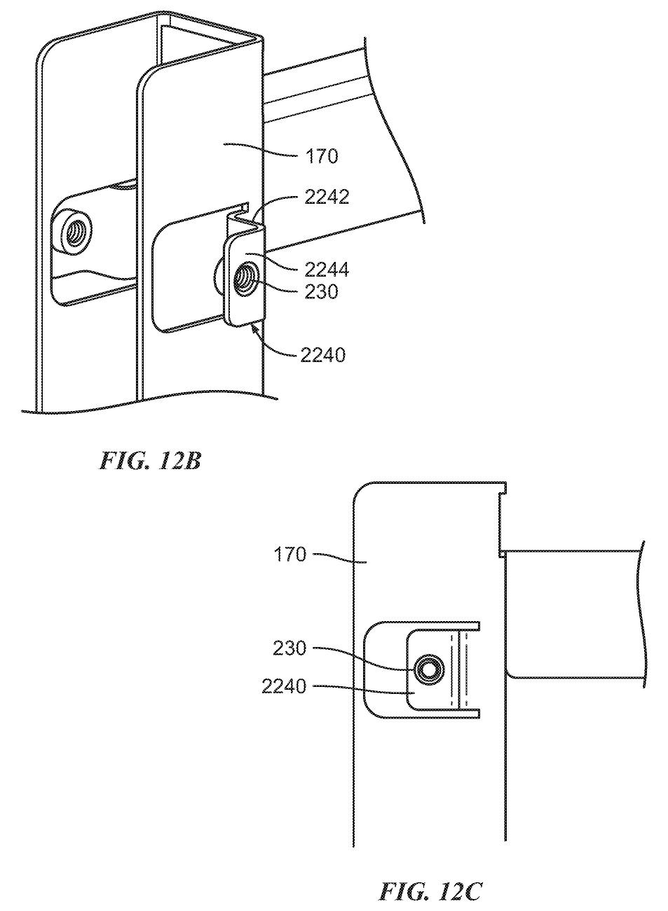

Referring to FIGS. 12A through 12C, a cart 2100 is substantially identical to the cart 100 of FIG. 1, except in substituting one or more offset mounts 2240 for one or more of the hooks 240 in the cart 100. Each offset mount 2240 has a projection 2242 extending outwardly from the member to which the one or more offset mounts 2240 is mounted—for example, extending outwardly from the upright member 170, as shown in FIG. 12B. Extending transversely from the projection, parallel to the member (upright member 170 in FIG. 12B), is an offset tab 2244, preferably with a sealingly and permanently attached nut, such as a welded nut or a self-clinching nut 230, inserted into or fixed thereto so that a shadow board or other supported element may be attached to the offset tab 2244 by a threaded fastener such as a bolt.

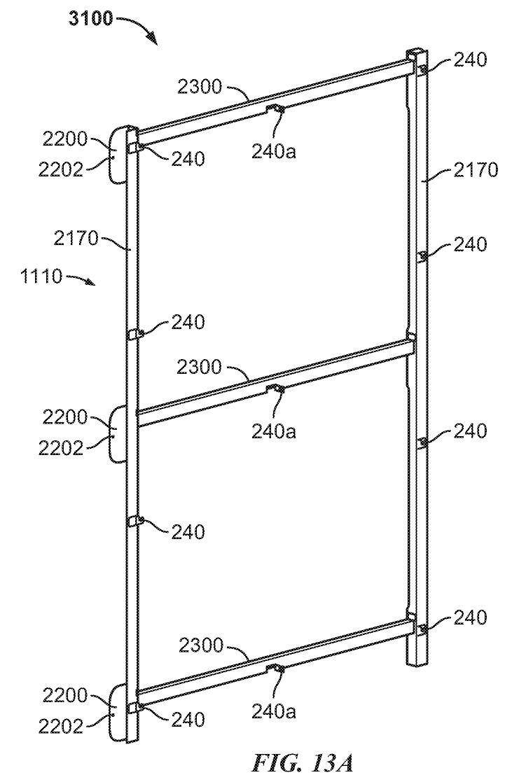

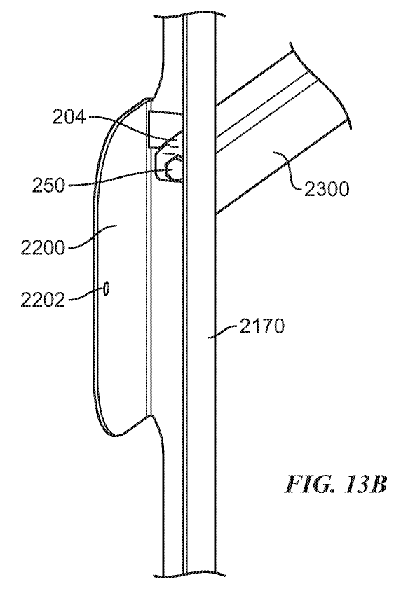

Referring to FIGS. 13A and 13B, a sanitary wall hanging frame 3100 includes a sanitary frame 1110. The sanitary wall hanging frame 2100 includes a sanitary frame 1110 adapted for mounting to a wall or other support. The sanitary frame 1110 is so adapted by having upright members 2170 adapted for mounting by having hook 240a mounted only to one side thereof. The sanitary frame 1110 includes mounting plates 2200 affixed to upright members 2170 and having mounting holes 2202 therein at accommodate fasteners to secure the sanitary frame 1110 to a wall or other structure. The upright members 2170 have an open cross section or may be solid and are secured to and air-gapped from the cross members 2300 in the same manner as the upright member 170 are secured to and air-gapped from the cross members 200. The cross members 2300 are substantially identical to the cross members 200 and are secured and air-gapped in the same manner as the cross members 200, with the exception that hooks 240a extend from only one side of the mounting plates 2200.

The elements disclosed herein may be formed of materials of sufficient strength, stillness, corrosion resistance, and other properties suited to a particular application. When the elements disclosed herein are intended for use under sanitary conditions, stainless steel is a particularly advantageous material for formation of elements, including one or more of the base elements 120, the transverse base members 150, the upright members 170, the cross members 200, the self-clinching nuts 230, the hooks 240, and the bolts 250.

It will be appreciated by those skilled in the art that various modifications and alterations could be made to the disclosure above without departing from the broad inventive concepts thereof. It is understood, therefore, that this invention is not limited to the particular embodiments disclosed, but it is intended to cover modifications within the spirit and scope of the present disclosure.

I/We claim:

1. A sanitary frame for a supported element, the sanitary frame comprising:
an upright member having an upright-member cross section, wherein the upright-member cross section is open-shaped;
a cross member having a cross-member cross section, wherein the cross-member cross section is open-shaped; and
a plurality of offset mounting elements, offset mounting element of the plurality of offset mounting elements being configured for supporting the supported element in spaced relation with at least one of the first upright member, the second upright member, or at least one cross member of the plurality of cross members.

2. The sanitary frame of claim 1, further comprising:
a second upright member having a second-upright-member cross section, wherein the second-upright-member cross section is open-shaped;
a second cross member, the second cross-member having a second-cross-member cross section, wherein the second-cross-member cross section is open-shaped.

3. The sanitary frame of claim 1, wherein each offset mounting element of the plurality of offset mounting elements comprises a hook extending outwardly from the upright member or the cross member, the hook being configured to support the supported element in spaced relation from the corresponding upright member or cross member.

4. The sanitary frame of claim 2, wherein each offset mounting element of the plurality of offset mounting elements comprises a hook extending outwardly from the upright member, the second upright member, or the cross member, the hook being configured to support the supported element in spaced relation from the corresponding upright member, second upright member, or cross member.

5. The sanitary frame of claim 1, further comprising a shadow board or washdown screen supported by the offset mounting elements, the shadow board or washdown screen being air gapped from the first upright member and the cross member of the sanitary frame such that liquid is prevented from being trapped between the shadow board or washdown screen and the first upright member and the cross member of the sanitary frame.

6. The sanitary frame of claim 2, further comprising a shadow board or washdown screen supported by the offset mounting elements, wherein the shadow board or washdown screen is air gapped from the first upright member, the second upright member, and the cross member of the sanitary frame such that liquid is prevented from being trapped between the shadow board or washdown screen and the first upright member, the second upright member, and the cross member of the sanitary frame.

7. The sanitary frame of claim 2, each cross member having first and second cross-mounting tabs at opposite ends thereof, with each cross member being attached in spaced relation to the first upright member and the second upright member by the first cross-mounting tab engaging the first upright member and the second cross-mounting tab engaging the second upright member.

8. The sanitary frame of claim 7, further comprising:
a first cross-member-attachment nut sealingly and permanently attached to the first cross-mounting tab; and
a second cross-member-attachment nut sealingly and permanently attached to the second cross-mounting tab

9. The sanitary frame of claim 1, further comprising a freestanding base supporting the first upright member in a vertical orientation, the freestanding base including:
a first base element and a second base element; and
a transverse base member extending from the first base element to the second base element, the transverse base member having a transverse-base-member cross section, wherein the transverse-base-member cross section is open-shaped.

10. The sanitary frame of claim 2, further comprising a freestanding base supporting the first upright member and the second upright member in a vertical orientation, the freestanding base including:
a first base element and a second base element; and
a transverse base member extending from the first base element to the second base element, the transverse base member having a transverse-base-member cross section, wherein the transverse-base-member cross section is open-shaped.

11. The sanitary frame of claim 9, wherein the transverse base member has first and second base-mounting tabs at opposite ends thereof, with each transverse base member being attached in spaced relation to the first base element and the second base element by the first and second base-mounting tabs.

12. The sanitary frame of claim 10, wherein the transverse base member has first and second base-mounting tabs at opposite ends thereof, with each transverse base member being attached in spaced relation to the first base element and the second base element by the first and second base-mounting tabs.

13. The sanitary frame of claim 11, further comprising:
a first transverse-base-member-attachment nut being sealingly and permanently attached to the first base-mounting tab and the first base element;
and a second transverse-base-member-attachment nuts being sealingly and permanently attached to the second base-mounting tab and the second base element.

14. The sanitary frame of claim 12, further comprising:
a first transverse-base-member-attachment nut being sealingly and permanently attached to the first base-mounting tab and the first base element;
and a second transverse-base-member-attachment nuts being sealingly and permanently attached to the second base-mounting tab and the second base element.

15. The sanitary frame of claim 1, wherein the cross member has a cross-member cross section that defines a gap, and the gap is oriented downwardly when the sanitary frame is in a an upright orientation.

16. The sanitary frame of claim 2, wherein each cross member has a cross-member cross section that defines a gap, and the gap is oriented downwardly when the sanitary frame is in a an upright orientation.

17. The sanitary frame of claim 8, wherein each cross-member-attachment nut comprises a self-clinching nut fixed to a corresponding cross-mounting tab.

18. The sanitary frame of claim 8, wherein each cross-mounting tab includes rounded or curved edges configured to reduce liquid harborage at a junction between the cross member and one of the first upright member or the second upright member.

19. The sanitary frame of claim 9, further comprising casters attached to the freestanding base.

20. The sanitary frame of claim 1, further comprising a freestanding base supporting the first upright member and the second upright member in a vertical orientation, the freestanding base including:
a first base element and a second base element; and
a transverse base member extending from the first base element to the second base element, the transverse base member having a transverse-base-member cross section, wherein the transverse-base-member cross section is open-shaped, the transverse base member having first and second base-mounting tabs at opposite ends thereof, with each transverse base member being attached in spaced relation to the first base element and the second base element by first and second transverse-base-member-attachment nuts, the first transverse-base-member-attachment nut being sealingly and permanently attached to the first base-mounting tab and the first base element, and the second transverse-base-member-attachment nuts being sealingly and permanently attached to the second base-mounting tab and the second base element.
